(19) United States
(12) Patent Application Publication
(10) Pub. No.: US 2023/0342321 A1
(43) Pub. Date: Oct. 26, 2023

(54) ENHANCED EYE-WIDTH MARGIN USING DUTY CYCLE ADJUST

(71) Applicant: Dell Products L.P., Round Rock, TX (US)

(72) Inventors: Douglas Winterberg, York, SC (US); Wan-Ju Kuo, Xindian District (TW); Bhyrav Mutnury, Austin, TX (US)

(21) Appl. No.: 17/728,191

(22) Filed: Apr. 25, 2022

(51) Int. Cl. G06F 13/40; G06F 13/16

(52) U.S. Cl. CPC G06F 13/4068; G06F 13/1668

(57) ABSTRACT

A high-speed data communication interface includes first and second lanes. The first lane includes a first transmitter coupled to send a first data signal to a first receiver via a first channel. The second lane includes a second transmitter coupled to send a second data signal to a second receiver via a second channel. The first channel injects crosstalk into the second channel. The second transmitter sets a duty cycle adjuster input to adjust a duty cycle of the second data signal to reduce the crosstalk.

### FIELD OF THE DISCLOSURE

This disclosure generally relates to information handling systems and more particularly relates to providing enhanced eye width margins using Duty Cycle Adjust in a high-speed data communication interface.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A high-speed data communication interface may include first and second lanes. The first lane may include a first transmitter coupled to send a first data signal to a first receiver via a first channel. The second lane may include a second transmitter coupled to send a second data signal to a second receiver via a second channel. The first channel may inject crosstalk into the second channel. The second transmitter may set a duty cycle adjuster input to adjust a duty cycle of the second data signal to reduce the crosstalk.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an high-speed data communication interface according to an embodiment of the current disclosure:

FIG. 2 is a flowchart illustrating a method for providing enhanced eye width margins using Duty Cycle Adjust in a high-speed data communication interface according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

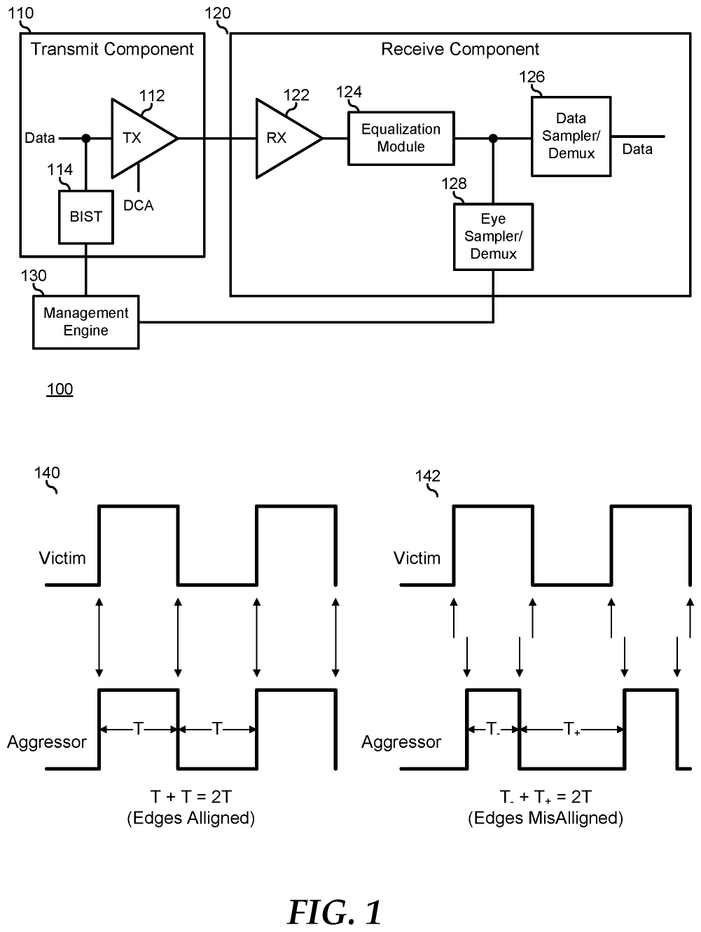

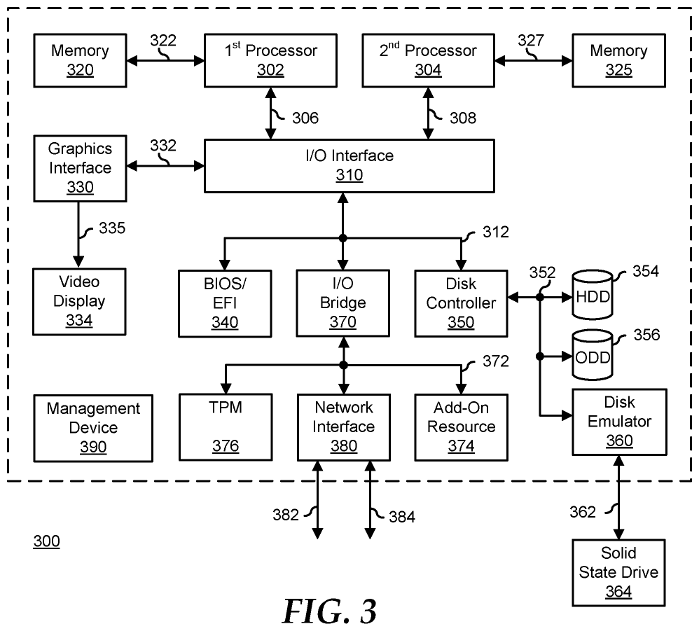

FIG. 1 illustrates a high-speed data communication interface 100, such as may be found in information handling system 300 in FIG. 3, as described below. High-speed data communication interface 100 includes a data transmitting component 110, a data receiving component 120, and a management engine 130. Data transmitting component 110 (hereinafter “transmitter 110”) operates to transmit data via a channel to and the data is received by data receiving component 120 (hereinafter “receiver 120”). The channel may be a single-ended data communication interface, as here illustrated, where the data signals are provided over a single conductor and the data values are provided with reference to a common reference voltage, typically a ground level, or the channel may be a double-ended data communication interface where the data signals are provided as differential signals over a pair of conductors, as needed or desired. High-speed data communication interface 100 represents a high-speed serializer/deserializer, in that transmitter 110 receives data and transmits the received data in a serialized fashion, and in that receiver 120 receives the serialized data from the transmitter and deserializes the data to extract the original data.

Examples of a high-speed data communication interface include a memory interface, such as a Double-Data Rate (DDR) interface, a Small Form Factor Pluggable (SFP+) interface for network communications, a Serial-ATA interface, a DisplayPort interface, a PCIe interface, a proprietary high-speed data communication interface, or the like. A typical high-speed data communication interface will include elements for bi-directional data communications. Thus, in a first case, a channel between a transmitter and a receiver may be utilized for bi-directional data transfers (for example DDR interfaces). Here, the typical transmitter component may include receive components as described herein that are coupled to the channel, and the typical receiver component may include transmit components as described herein that are coupled to the channel. In another case, a separate channel may be utilized for data transmission from the receiver component to the transmitter component (for example PCIe interfaces). A typical information handling system will include multiple high-speed data communication interfaces combined to form a larger group of related high-speed data communication interfaces. Here, a single high-speed data communication interface may be referred to as a lane, and the group of high-speed data communication interfaces may be referred to as a link or a bus. The details of high-speed data communication interfaces are known in the art and will not be further described herein, except as needed to illustrate the current embodiments.

Transmitter 110 includes a physical layer transmitter 112 (hereinafter “transmit PHY 112”), and a Built-In Self Test (BIST) module. In a normal data transmission operating mode, transmit PHY 112 receives data, and converts the received data into electrical signals on the channel to receiver 120. Transmit PHY 112 includes a Duty Cycle Adjuster (DCA) input. In some cases, such as in parallel bus type high-speed data communication interfaces, like DDR data communication interfaces, the data conversion may include a bit-by-bit translation of the received data bits into associated signals on the channel. In other cases, such as serial type high-speed data communication interfaces, like PCIe data communication interfaces, the data conversion may include an encoding step, such as an 8-bit/10-bit encoding, to ensure adequate state changes are received in the receiver for clock recovery or the like. The operation of BIST module 114 will be described further below.

The DCA input to transmit PHY 112 operates to change the duty cycle of the output signal. For example, a pair of signals on adjacent lanes of a high-speed data communication interface such are illustrated 140 and 142. Here, in a nominal case 140, both the victim lane and the aggressor lane are set with nominal DCA settings, that is, with no changes to the duty cycle of the signals on the associated lanes. Here, it can be seen that transitions in the signal value from a logic “0” to a logic “1,” or from a logic “1” to a logic “0,” are aligned in time between the victim lane and the aggressor lane. Also, the time each signal remains in the logic “0” state and the time each signal remains in the logic “1” state are equal (T) and the period of the signal (2T) is provided as:

T+T=2T Equation 1.

In a DCA case 142, the aggressor lane retains the nominal DCA setting, with no change to the duty cycle of the aggressor lane. Here, the time the aggressor signal remains in the logic “0” state and the time aggressor signal remains in the logic “1” state are equal (T) and the period of the signal (2T) is provided as defined in Equation 1, above. However, the victim lane has a DCA setting that offsets the transitions from the logic “0” to the logic “1,” and from the logic “1” to the logic “0.” In particular, the time the victim signal remains in the logic “0” state is increased (T₊) and the time the victim signal remains in the logic “1” state is decreased (T₋), while the period (2T) of the signal remains constant, as:

T₊+T₋=2T Equation 2.

Note that the use of the DCA input to transmit PHY 112 may operate in an opposite sense as described above, with the time the victim signal remains in the logic “0” state being decreased (T) and the time the victim signal remains in the logic “1” state is increased (T+), as needed or desired.

Receiver 120 includes a physical layer receiver 122 (hereinafter “receive PHY 122”), an equalization module 124, a data sampler/demultiplexor 126, and an eye sampler/demultiplexor 128. In the normal operating mode, receive PHY 122 receives the electrical signals from the channel. It will be understood that in a typical high-speed data communication interface, the data stream as provided to transmit PHY 112 is not simply “read” from an output of receive PHY 122. This is because the margins for voltage levels and the time duration of the received signals are so small that the distortion effects from the channel result in a received signal that is typically unrecognizable as data without significant post-processing to recover the data stream. As such, the output from receive PHY 122 is provided to equalization module 124 for processing, and the output of equalization module is provided to data sampler/demultiplexor 126 before the data stream is recovered.

Equalization module 124 operates to clean up the received signal from receive PHY 122 by compensating for the distortion effects from the channel. For example, equalization module 124 may include an automatic gain control (AGC) module, a continuous-time linear equalization (CTLE) module, and decision feedback (DFE) module, or other equalization modules as needed or desired. An AGC module is a feedback amplifier that operates to amplify the received signal from a transmitter to provide a constant level signal to the rest of the elements of the receiver. A CTLE module is a linear fitter that attenuates low-frequency components of the signal received from an AGC module that amplifies components of the signal around the Nyquist frequency of the signal, and fitters off high-frequency components of the signal. A DFE module is a non-linear equalization which relies on decisions about the levels of previous symbols (high/low) in the signal received from the transmitter in order to clean up a current symbol, thereby accounting for distortion in the current symbol that is caused by the previous symbols. The details of channel equalization, and in particular of AGC, CTLE, and DFE equalizations are known in the art and will not be further described herein, except as needed to illustrate the current embodiments. The result of the processing by equalization module 124 is to present a clean data eye to data sampler/demultiplexor 126 which extracts the data stream from the data eye for use by other elements of receiver 120 as needed or desired. The details of data recovery in a receiver of a high-speed data communication interface are known in the art and will not be further described herein, except as needed to illustrate the current embodiments.

Eye sampler/demultiplexor 128 is similar to data sampler/demultiplexor 126, and receives the data eye. Here, the data eye represents a flow of data bits on the channel that can be depicted an instrument trace of multiple data bits from the data stream. As such, data sampler/demultiplexor 126 is focused upon extracting the individual data bits from the data stream, while eye sampler/demultiplexor 128 is focused on the issues of the quality of the data eye, and particularly on determining the eye height and eye width of the data eye to ensure that sufficient margins are maintained as a result of the equalization process performed by equalization module 124.

In various embodiments, eye sampler/demultiplexor 128 operates in a training mode to provide feedback as to the sufficiency and consistency of the settings of the various stages of the equalization blocks in maintaining adequate margins in the data eye to improve the ability of data sampler/demultiplexor 130 to detect the data stream and to reduce the bit error rate of the detection process. In other embodiments, eye sampler/demultiplexor 132 operates in a run time mode to detect changes in the data eye and to proactively notify of the changes, or to amend the settings of the various stages of equalization blocks to maintain the bit error rate within satisfactory levels.

In a particular embodiment, in the training mode, eye sampler/demultiplexor 128 coordinates link training with transmitter 110. Here, management engine 130 operates to communicate training results from eye sampler/demultiplexor 128 to BIST module 114 to determine when the settings of the various stages of equalization module 124 have converged on a satisfactory set of values to create the adequate margins in the data eye. Here, during a power-on phase, BIST module 114 operates to transmit training data via transmit PHY 112 and eye sampler/demultiplexor 128, upon detecting an unsatisfactory data eye, systematically adjusts the settings within equalization module 124, until the detected eye exhibits the adequate margin to ensure that the bit error rate remains below a predetermined level. In another embodiment, the training is repeatedly performed. Here, it is understood that the same or similar settings for equalization module 124 will be expected, and eye sampler/multiplexor 132 selects as a final set of setting values the setting values that represent a best set of setting values. The best set of setting values can be determined as a most commonly reoccurring value for each setting, as an average of the values over the repeated training runs, as the value for each setting that exhibited the best eye margins, or other methods for analyzing the values of the repeated training runs.

It has been understood by the inventors of the current disclosure that crosstalk between lanes of a high-speed data communication interface can have a significant negative impact on the eye width margins of the data eye at a receiver. In particular, in DDR type memory interfaces, such as a fifth generation (DDR5) interface, the individual lanes are typically tightly routed so as to have all signals arrive at the receiver at the same time. However, such tight routing creates an enhanced environment for crosstalk between the lanes. Crosstalk is traditionally handled by spacing the lanes further apart, but such an approach results in less efficient utilization of PCB real estate, and the consequent increase in the number of PCB layers needed to accommodate DDR channels (e.g. from 8-layer PCBs to 12-layer PCBs).

In a particular embodiment, as illustrated in the DCA case 142, the DCA input to transmit PHY 112 is adjusted to intentionally misalign the signal transition edges of a victim lane that is experiencing poor eye width margins. In this way, the cumulative effect of switching transients from neighboring aggressor lanes on the victim lane are not added in with the switching transients of the victim lane, thereby improving the eye width margin of the victim lane. For example, the JEDEC specification for DDR5 interfaces includes a specified DCA input to a transmit PHY. By utilizing this input in DDR5 interfaces on a victim lane that experiences poor eye width margin, the eye width margin for the victim lane may be significantly improved. In a particular embodiment, the eye width margin of a victim lane can be improved up to 25% over normally aligned signaling.

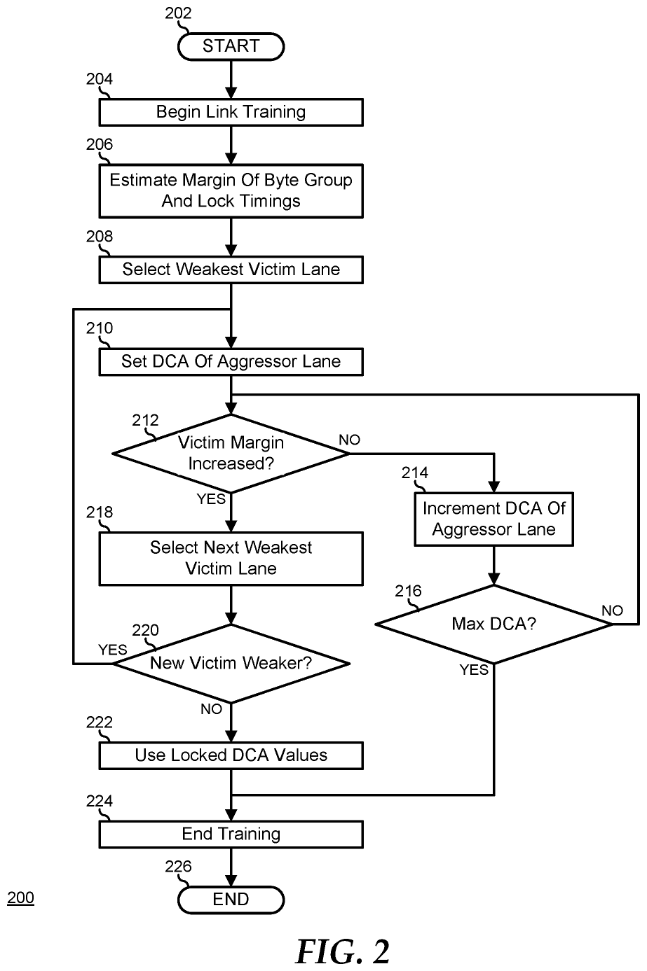

FIG. 2 illustrates a method 200 for providing enhanced eye width margins using DCA in a high-speed data communication interface, starting at block 202. Link training is initiated in block 204. The details of link training are highly dependent upon the type of high-speed data communication interface that is being trained and known in the art, and will not be further described herein except as may be needed to illustrate the current embodiments. The eye height and eye width margins for each lane in the high-speed data communication interface are determined and the equalization settings are locked in block 206. Based upon the eye width margins for each lane, a weakest lane, in terms of eye width, is determined in block 208. The DCA settings for the adjacent lanes (the aggressor lanes) to the weakest lane are set to manipulate the aggressor lanes to incrementally adjust their duty cycles in block 210.

A decision is made as to whether or not the eye width margin for the victim lane has increased in decision block 212. If not, the “NO” branch of decision block 212 is taken and the DCA settings for the aggressor lanes are incrementally adjusted again in block 214. A decision is made as to whether or not the DCA settings for the aggressor lanes are at a maximum value in decision block 216. If not, the “NO” branch of decision block 216 is taken and the method returns to decision block 212 where the decision is made as to whether or not the modified DCA settings have increased the eye width margin of the victim lane. If the DCA settings for the aggressor lanes are at a maximum value, the “YES” branch of decision block 216 is taken, the link training is ended in block 224, and the method ends in block 226.

Returning to decision block 212, if the eye width margin for the victim lane has increased, the “YES” branch of the decision block is taken, and a next weakest victim lane is selected in block 218. A decision is made as to whether or not the new victim lane has a weaker margin that the adjusted (original) victim lane in decision block 220. If so, the “YES” branch of decision block 220 is taken and the method proceeds to block 210, where the DCA settings for the adjacent lanes (the aggressor lanes) to the next weakest lane are set to manipulate the aggressor lanes to incrementally adjust their duty cycles. If the new victim lane does not have a weaker margin that the adjusted (original) victim lane, the “NO” branch of decision block 220 is taken and the DCA values for all lanes are locked in block 222. The link training is ended in block 224, and the method ends in block 226.

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A high-speed data communication interface, comprising:
a first lane including a first transmitter configured to send a first data signal to a first receiver via a first channel; and
a second lane including a second transmitter configured to send a second data signal to a second receiver via a second channel, wherein the first channel injects crosstalk into the second channel, and wherein the second transmitter is configured to set a duty cycle adjuster input to adjust a duty cycle of the second data signal to reduce the crosstalk.

2. The high-speed data communication interface of claim 1, wherein, at a time prior to setting the duty cycle adjuster, the second receiver is configured to determine a first eye width of the second data signal.

3. The high-speed data communication interface of claim 2, wherein, after setting the duty cycle adjuster, the second receiver is further configured to determine a second eye width of the second data signal.

4. The high-speed data communication interface of claim 3, wherein the second receiver is further configured to determine that the second eye width is greater than the first eye width.

5. The high-speed data communication interface of claim 4, wherein the second receiver is further configured to direct the second transmitter to set the duty cycle adjuster in response to determining that the second eye width is greater than the first eye width.

6. The high-speed data communication interface of claim 1, wherein a first period of the first data signal is provided as 2T, where T is a duration that the first data signal is in both a first portion of the period a second portion of the period.

7. The high-speed data communication interface of claim 6, wherein in adjusting the duty cycle of the second data signal, a second period of the second data signal is provided as 2T=T₊+T₋, where T₊ is not equal to T₋.

8. The high-speed data communication interface of claim 1, wherein setting the duty cycle adjuster input is during a training phase for the high-speed data communication interface.

9. The high-speed data communication interface of claim 1, wherein in adjusting the duty cycle of the second data signal, a first edge of the first data signal is misaligned with a corresponding second edge of the second data signal.

10. The high-speed data communication interface of claim 1, wherein the high-speed data communication interface is a fifth generation Double Data Rate (DDR5) memory interface.

11. A method, comprising:
sending, on a first lane of a high-speed data communication interface, a first data signal from a first transmitter of the first lane to a first receiver of the first lane via a first channel of the first lane;
sending, on a second lane of a high-speed data communication interface, a second data signal from a second transmitter of the second lane to a second receiver of the second lane via a second channel of the second lane, wherein the first channel injects crosstalk into the second channel; and
directing the second transmitter to set a duty cycle adjuster input of the second transmitter to adjust a duty cycle of the second data signal to reduce the crosstalk.

12. The method of claim 11, wherein, at a time prior to setting the duty cycle adjuster, the method further comprises:
determining, by the second receiver, a first eye width of the second data signal.

13. The method of claim 12, wherein, after setting the duty cycle adjuster, the method further comprises:
determining, by the second receiver, a second eye width of the second data signal.

14. The method of claim 13, further comprising:
determining, by the second receiver, that the second eye width is greater than the first eye width.

15. The method of claim 14, directing the second transmitter to set the duty cycle adjuster is in response to determining that the second eye width is greater than the first eye width.

16. The method of claim 11, wherein a first period of the first data signal is provided as 2T, where T is a duration that the first data signal is in both a first portion of the period a second portion of the period.

17. The method of claim 16, wherein in adjusting the duty cycle of the second data signal, a second period of the second data signal is provided as 2T=T₊+T₋, where T₊ is not equal to T₋.

18. The method of claim 11, wherein setting the duty cycle adjuster input is during a training phase for the high-speed data communication interface.

19. The method of claim 11, wherein in adjusting the duty cycle of the second data signal, a first edge of the first data signal is misaligned with a corresponding second edge of the second data signal.

20. A method, comprising:
determining, in a receiver of a high-speed data communication interface, a first eye width margin for a signal received by the receiver from a transmitter of the high-speed data communication interface;
directing the transmitter to provide a first adjustment to a duty cycle of the signal;
determining, in the receiver a second eye width margin for the adjusted signal form the transmitter;
determining whether or not the second eye width margin is greater than the first eye width margin;
in response to determining that the second eye width margin is not greater than the first eye width margin, directing the transmitter to provide a second adjustment to the duty cycle of the signal; and
in response to determining that the second eye width margin is greater than the first eye width margin, directing the transmitter to maintain the first adjustment.
